(19) United States
(12) Patent Application Publication
(10) Pub. No.: US 2007/0102970 A1
(43) Pub. Date: May 10, 2007

(54) Anatomically correct bicycle saddle

(76) Inventor: John D. Wallace, Denver, CO (US)

Correspondence Address: John D. Wallace III, 3745 Vine St., Denver, CO, 80205, US

(21) Appl. No.: 11/257,277

(22) Filed: Oct. 24, 2005

(51) Int. Cl. B62J 1/00

(52) U.S. Cl. 297/215.1

(57) ABSTRACT

An improved bicycle seat that offers superior comfort in any bicycling application, especially over long distances. A sturdy integrated base-plate and frame (10) supports the cushion (6) and attaches to the seat post (P). The back edge (14) curves upward to prevent the rider from sliding backwards. The front edges (12A and 12B) curve downward to facilitate pedaling motion. A ridge (16) fits in between the riders' buttocks to keep the rider centered and prevent lateral slippage. The u-shaped cut-out (8) ensures that no pressure is exerted upon the perineum. The body weight of the rider is thus diffused throughout the entire buttock region, which substantially reduces fatigue, discomfort, and the possibility of permanent injury.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to bicycles, particularly to a bicycle seat which distributes the body weight of the rider evenly throughout the entire buttock region, instead of only a fraction thereof and the crotch area.

2. Prior Art

The conventional bicycle seat, which is somewhat pear-shaped, has not evolved much over time. The most problematic area of this design is the front part that juts forward between the legs of the rider. This causes pressure to be exerted upon the genital region which, especially if the rider is male, can be at least uncomfortable and at worst dangerous. According to recent medical studies, this pressure compresses nerves and blood vessels and reduces blood flow; this compression can become permanent. Also, the back portion of the conventional seat is not wide enough to properly support the rider's weight, so that the perineum and surrounding area must bear a large portion of the rider's weight. Evidence of this lies in the fact that one never sees a chair that is only 12 cm wide.

Several prior art examples exist which have attempted to address these issues. Unfortunately, few tackle effectively the problem of pressure on the groin area, or, if they do, then the rear portion of the seat is not wide enough to fully support the rider which reduces comfort. See, for example, U.S. Pat. No. 4,773,705 (1988), and U.S. Pat. No. 6,554,355 (2003), U.S. Pat. No. 6,755,464 (2004).

3. Objects and Advantages

Accordingly, several objects and advantages of the present invention are:

(a) to provide a bicycle seat unsurpassed in comfort;

(b) to design a bicycle seat which cannot be improved;

(c) to provide a bicycle seat that will fit the anatomy of virtually any rider;

(d) to provide a bicycle seat that eliminates pressure on the perineum, which can cause erectile dysfunction in men;

(e) to build a bicycle seat that provides superior durability.

Further objects and advantages are to provide a saddle that elevates the design and functionality of the seat to the level of the rest of the bicycle's components, which are now quite sophisticated and advanced.

### SUMMARY

An improved bicycle seat that substantially reduces the amount of fatigue and discomfort a rider feels in the area where his or her body comes in contact with the seat. This is accomplished by removing all pressure from the front of the pelvic region and shifting it towards the back, where it is diffused evenly throughout the buttocks.

### DRAWINGS—FIGURES

FIG. 1 shows an isometric view from top right.

FIG. 2 shows a view from above and indicates the position of the saddle in relation to the bicycle's seat post.

FIG. 3 shows a front view and indicates frame and base-plate structure.

FIG. 4 shows a rear view.

FIG. 5 shows a side view.

### DRAWINGS—FIGURES

6 cushion
8 u-shaped cut-out
10 integrated base-plate and frame
12A, 12B front edges
14 back edge
16 central ridge

### DETAILED DESCRIPTION

The following description illustrates the invention by way of example and not by way of limitation. For those skilled in the art, this description will enable them to build and use the saddle. It is imperative to note that it is the shape and configuration of the actual seat that is of paramount importance. The shape of the frame is less important and may be altered as necessary. Therefore, it is intended that the contents of this description and details shown in the accompanying drawings shall be interpreted as illustrative and not in a limiting sense.

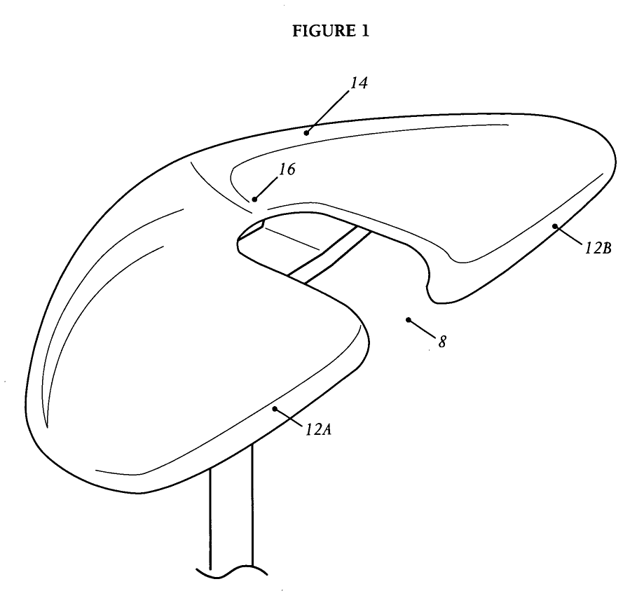

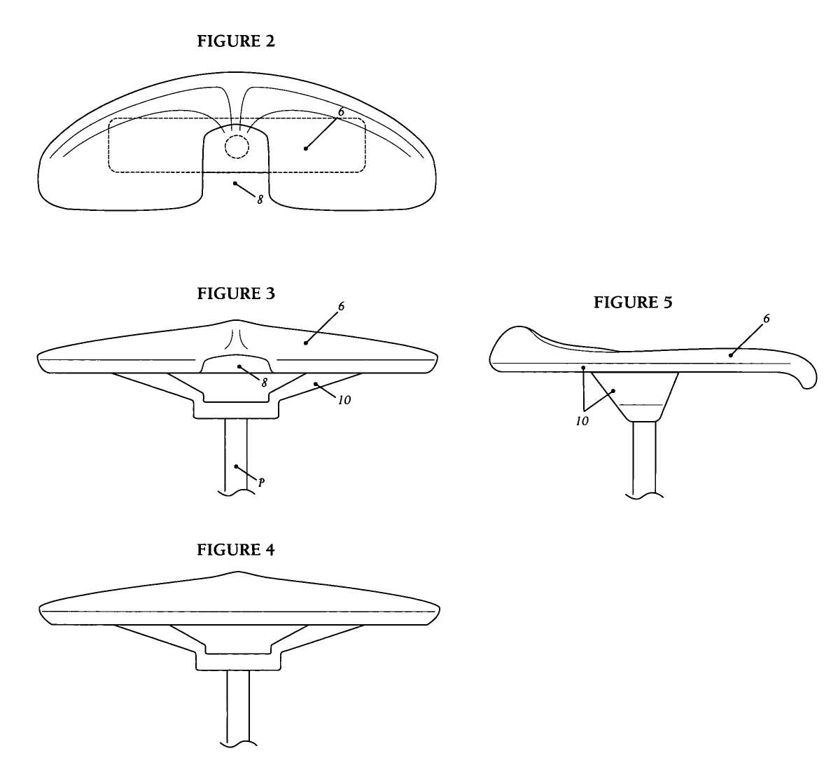

A preferred embodiment of the bicycle seat of the present invention is shown in FIGS. 1 through 5. The bicycle frame includes a seat post P to which an integrated base-place and frame 10 is mounted. The bicycle seat indicated in FIG. 5 is formed of the integrated base-plate and frame 10 and a cushion 6. The frame is v-shaped for strength purposes and to reduce the number of pieces during manufacture. The frame is secured to the seat post P in any convenient manner.

The seat is flat except for front edges 12A and 12B (FIG. 1), which curve gently downwards to facilitate pedaling motion, and a back edge 14 (FIG. 1), which curves upward to prevent the rider from sliding backward. A u-shaped cut-out 8 (FIG. 1) focuses the rider's body weight upon the ischial tuberosity, or “sit-bones,” and away from the perineum and surrounding nerves and blood vessels. A central ridge 16 (FIG. 1) keeps the rider centered and reduces-lateral slippage.

The cushion 6 (FIG. 5) may be formed of an elastomer foam, such as polyethylene. The integrated base-plate and frame 10 may be formed of aluminum alloy or other suitable metal composite.

Accordingly, the reader will see that the structure of this invention is radically different from that of a conventional bicycle seat. The reason for this is that the conventional seat puts pressure on the perineum. Several medical studies (see New York Times, Oct. 4, 2005) have proven beyond a shadow of a doubt that this can cause impotence and testicular cancer in males. Women cyclists have not been studied as much, but they probably suffer similar injuries. The problem of pressure on the perineum is completely eliminated by the u-shaped cut-out 8.

Having thus described the invention, what is claimed and desired to be secured by Letters Patent is:

1. A bicycle seat comprising:
A seat means formed of an elongated support member of predetermined dimensions having a cushion and a rigid integrated base-plate and frame;
Said support member having a generally rectangular configuration, with the longer edges being perpendicular to the bicycle frame;
Said support member having a u-shaped cut-out of predetermined cross-sectional shape in the front that runs parallel to the bicycle frame, whereby the rider sits comfortably with no pressure exerted on the perineum;
Said support member having front edges that curve downward;
Said support member having a back edge that curves upward, whereby the rider is prevented from sliding backward;
Said support member having a ridge that runs parallel to the bicycle frame from the center of the back edge to the center of the u-shaped cut-out, whereby the rider is prevented from sliding laterally;
Said integrated base-plate and frame having a v-shaped frame extending downwards;
Said integrated base-plate and frame having a means of attaching it to the seat post.

2. The supporting member of claim 1 wherein said integrated base-plate and frame is formed of aluminum alloy.

3. The supporting member of claim 1 wherein said cushion and integrated base-plate and frame are joined together in any manner convenient to the state of the art.

4. The supporting member of claim 1 wherein said back edge forms the shape of a triangle with the apex at the base of the riders' spine.
